(19) United States
(12) Patent Application Publication
(10) Pub. No.: US 2004/0084642 A1
(43) Pub. Date: May 6, 2004

(54) System and method for squeeze film damping precision assemblies

(76) Inventor: Mats Anders Engwall, San Juan Bautista, CA (US)

Correspondence Address: The Law Office of Steven G. Roeder, 5560 Chelsea Avenue, La Jolla, CA, 92037, US

(21) Appl. No.: 10/288,074

(22) Filed: Nov. 4, 2002

(51) Int. Cl. G01V 8/00; G01N 21/86

(52) U.S. Cl. 250/559.29

(57) ABSTRACT

An apparatus for moving and positioning a device (14) includes a stage assembly (24) and a first mirror component (226). The stage assembly (24) includes a device stage (202) that retains the device (14) and a stage mover assembly (204) that moves the device stage (202). The first mirror component (226) is secured to the device stage (202) and is used for monitoring the position the device stage (202). A first fluid gap (348) exists between the first mirror component (226) and the device stage (202). The first fluid gap (348) provides squeeze film damping of the first mirror component (226) along a first axis. Additionally a second fluid gap (352) can exist between the first mirror component (226) and the device stage (202). The second fluid gap (352) provides squeeze film damping of the first mirror component (226) along a second axis that is orthogonal to the first axis.

### FIELD OF THE INVENTION

The present invention is directed to a stage assembly for moving a device. More specifically, the present invention is directed to a system and method for squeeze film damping in precision assemblies.

### BACKGROUND

Exposure apparatuses are commonly used to transfer images from a reticle onto a semiconductor wafer during semiconductor processing. A typical exposure apparatus includes an illumination source, a reticle stage assembly having a reticle stage that retains a reticle, a lens assembly, a wafer stage assembly having a wafer stage that retains a semiconductor wafer, a measurement system, and a control system. The reticle stage assembly and the wafer stage assembly are supported above a ground with an apparatus frame.

The reticle stage assembly includes a reticle mover assembly that moves the reticle stage and the reticle to precisely position the reticle relative to the lens assembly and the wafer. Similarly, the wafer stage assembly includes a wafer mover assembly that moves the wafer stage and the wafer to precisely position the wafer. The size of the images transferred onto the wafer from the reticle is extremely small. Accordingly, the precise relative positioning of the wafer and the reticle is critical to the manufacturing of high density, semiconductor wafers.

In order to obtain precise relative positioning, the reticle and the wafer are constantly monitored by the measurement system. Stated another way, the measurement system monitors the movement of the wafer stage and the reticle stage relative to the lens assembly or some other reference. With this information, the reticle mover assembly can precisely position the reticle stage and the wafer mover assembly can be used to precisely position the wafer stage.

The measurement system typically includes one or more interferometers for monitoring the position of the reticle stage and one or more interferometers for monitoring the position of the wafer stage. For example, the measurement system can include one or more interferometers that monitor the position of the wafer stage along an X axis, along a Y axis and about a Z axis. Each interferometer can include a mirror that is secured to the wafer stage and an interferometer block that generates and directs one or more laser beams at the mirror and detects the beams that are reflected off of the mirror. With this information, the location of the wafer stage can be determined.

Unfortunately, movement of the wafer stage can cause vibration of the mirror. The vibration of the mirror can adversely influence the accuracy of the measurements taken with the interferometer. This reduces the accuracy of positioning of the wafer relative to the reticle and degrades the accuracy of the exposure apparatus.

In light of the above, there is a need for a stage assembly that precisely positions a device. Additionally, there is a need for a method and system for damping vibration between the mirrors and the stage and damping vibration between other precision assemblies. Moreover, there is a need for an exposure apparatus capable of manufacturing precision devices such as high density, semiconductor wafers.

### SUMMARY

The present invention is directed of an apparatus that includes a stage assembly and a mirror component. The stage assembly includes a device stage that retains a device and a stage mover assembly that moves the device stage and the device. The mirror component is secured to the device stage and is used for monitoring the position the device table. A first fluid gap exists between the mirror component and the device stage. The first fluid gap provides squeeze film damping of the mirror component along a first axis.

A number of designs are provided herein. For example, the first fluid gap can be formed directly between a stage adjoining surface on the device stage and a component adjoining surface on the mirror component. In this design, the stage adjoining surface can be substantially planar shaped and the component adjoining surface can be slightly arched shaped. Alternatively, the stage adjoining surface can be slightly arch shaped and the first component adjoining surface can be substantially planar shaped. Still alternatively, the stage adjoining surface can be slightly arch shaped and the component adjoining surface can be slightly arched shaped.

In yet another design, the apparatus includes a first damping unit positioned between the mirror component and the device stage. In this design, the first fluid gap can be positioned between the mirror component and the first damping unit. Alternatively, the first fluid gap can be positioned between the first damping unit and the device stage. Still alternatively, the first fluid gap can include a first, first fluid gap positioned between the mirror component and the first damping unit and a second, first fluid gap positioned between the first damping unit and the device stage.

In still another embodiment, a second fluid gap exists between the mirror component and the device stage. The second fluid gap provides squeeze film damping of the mirror component along a second axis that is substantially orthogonal to the first axis. In this design, the fluid gaps cooperate to provide torsional damping of the mirror component.

The present invention is also directed to an assembly that includes a stage, a stage mover assembly that moves the stage, and a first rigid component that is secured to the stage. In this embodiment, a first fluid gap and a second fluid gap exists between the first rigid component and the stage. The first fluid gap provides squeeze film damping of the first rigid component along the first axis and the second fluid gap provides squeeze film damping of the first rigid component along the second axis that is substantially orthogonal to the first axis.

The present invention is also directed to an exposure apparatus, a device made with the exposure apparatus, a wafer made with the exposure apparatus, a method for making a stage assembly, a method for making an exposure apparatus, a method for making a device, a method for manufacturing a wafer, and a method for damping vibration between two components.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side illustration of an exposure apparatus having features of the present invention;

FIG. 2 is a perspective view of a stage assembly and a measurement system having features of the present invention;

FIG. 3A is a perspective view of a device stage and mirror component having features of the present invention;

FIG. 3B is an exploded perspective view of a device stage and mirror components of FIG. 3A;

FIG. 3C is a side view of the device stage and mirror components of FIG. 3A;

FIG. 3D is a cross-sectional view taken on line 3D-3D in FIG. 3C;

FIG. 3E is a cross-sectional view taken on line 3E-3E in FIG. 3C;

FIG. 3F is a cross-sectional view taken on line 3F-3F in FIG. 3C;

FIG. 4A is a perspective view of another embodiment of the device stage and mirror components having features of the present invention;

FIG. 4B is an exploded perspective view of the device stage and mirror components of FIG. 4A;

FIG. 5A is a perspective view of still another embodiment of the device stage and mirror components having features of the present invention;

FIG. 5B is an exploded perspective view of a device stage and mirror components of FIG. 5A;

FIG. 6A is a perspective view of yet another embodiment of the device stage and mirror components having features of the present invention;

FIG. 6B is an exploded perspective view of a device stage and mirror components of FIG. 6A;

FIG. 7A is a flow chart that outlines a process for manufacturing a device in accordance with the present invention; and

FIG. 7B is a flow chart that outlines device processing in more detail.

### DESCRIPTION

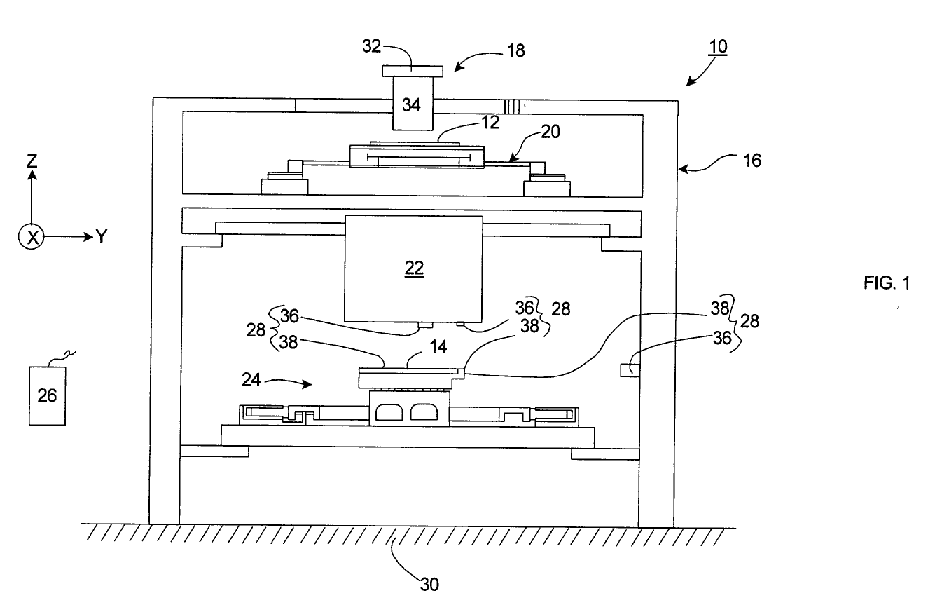

The present invention relates to a device and method for damping vibration in one or more components of a precision assembly. FIG. 1 is a schematic view that illustrates a precision assembly, namely an exposure apparatus 10. The exposure apparatus 10 is particularly useful as a lithographic device that transfers a pattern (not shown) for an integrated circuit from a reticle 12 onto the semiconductor wafer 14. In FIG. 1, the exposure apparatus 10 includes an apparatus frame 16, an illumination system 18 (irradiation apparatus), a reticle stage assembly 20, an optical assembly 22 (lens assembly), a wafer stage assembly 24, a control system 26, and a measurement system 28. The exposure apparatus 10 mounts to a mounting base 30, e.g., the ground, a base, or floor or some other supporting structure. The design of the components of the exposure apparatus 10 can be varied to suit the design requirements of the exposure apparatus 10.

As an overview, the measurement system 28 monitors the position of the reticle 12 and the wafer 14 relative to the optical assembly 22. In this embodiment, the exposure apparatus 10 is uniquely designed to utilize squeeze film damping to dampen vibration of one or more components of the measurement system 28. As a result thereof, the measurement system 28 can more accurately monitor the relative positions of the reticle 12 and the wafer 14. This improves the positioning performances of the stage assemblies 20, 24 and allows for more accurate positioning of the semiconductor wafer 14 relative to the reticle 12.

Alternatively, squeeze film damping type can be utilized for damping vibration of other components of the exposure apparatus 10. Still alternatively, the devices and methods for damping vibration provided herein can be used in other precision assemblies, including other semiconductor processing equipment, machine tools, metal cutting machines, and inspection machines.

A number of Figures include an orientation system that illustrates an X axis, a Y axis that is orthogonal to the X axis and a Z axis that is orthogonal to both X and Y axes. It should be noted that these axes can also be referred to as the first, second and third axes.

There are a number of different types of lithographic devices. For example, the exposure apparatus 10 can be used as scanning type photolithography system that exposes the pattern from the reticle 12 onto the wafer 14 with the reticle 12 and the wafer 14 moving synchronously. In a scanning type lithographic device, the reticle 12 is moved perpendicular to an optical axis of the optical assembly 22 by the reticle stage assembly 20 and the wafer 14 is moved perpendicular to the optical axis of the optical assembly 22 by the wafer stage assembly 24. Scanning of the reticle 12 and the wafer 14 occurs while the reticle 12 and the wafer 14 are moving synchronously.

Alternatively, the exposure apparatus 10 can be a step-and-repeat type photolithography system that exposes the reticle 12 while the reticle 12 and the wafer 14 are stationary. In the step and repeat process, the wafer 14 is in a fixed position relative to the reticle 12 and the optical assembly 22 during the exposure of an individual field. Subsequently, between consecutive exposure steps, the wafer 14 is consecutively moved with the wafer stage assembly 24 perpendicularly to the optical axis of the optical assembly 22 so that the next field of the wafer 14 is brought into position relative to the optical assembly 22 and the reticle 12 for exposure. Following this process, the images on the reticle 12 are sequentially exposed onto the fields of the wafer 14 so that the next field of the wafer 14 is brought into position relative to the optical assembly 22 and the reticle 12.

However, the use of the exposure apparatus 10 provided herein is not limited to a photolithography system for semiconductor manufacturing. The exposure apparatus 10, for example, can be used as a Liquid Crystal Display photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask closely located relative to the substrate, without the use of a lens assembly.

The apparatus frame 16 is rigid and supports the components of the exposure apparatus 10. The apparatus frame 16 illustrated in FIG. 1 supports the optical assembly 22, the illumination system 18, and the stage assemblies 20, 24 above the mounting base 30.

The illumination system 18 includes an illumination source 32 and an illumination optical assembly 34. The illumination source 32 emits a beam (irradiation) of light energy. The illumination optical assembly 34 guides the beam of light energy from the illumination source 32 to the reticle 12. The beam selectively illuminates different portions of the reticle 12 and exposes the semiconductor wafer 14. In FIG. 1, the illumination source 32 is illustrated as being supported above the reticle stage assembly 20. Typically, however, the illumination source 32 is secured to one of the sides of the apparatus frame 16 and the energy beam from the illumination source 32 is directed to the reticle stage assembly 20 with the illumination optical assembly 34.

The illumination source 32 can be a g-line source having a wavelength of 436 nm, an i-line source having a wavelength of 365 nm, a KrF excimer laser having a wavelength of 248 nm, an ArF excimer laser having a wavelength of 193 nm, or a F₂ laser having a wavelength of 157 nm. Alternatively, the illumination source 32 can also use charged particle beams such as an x-ray, and/or an electron beam. For instance, when the illumination source 32 generates an electron beam, thermionic emission type lanthanum hexaboride (LaB₆) or tantalum (Ta) can be used as cathodes in an electron gun. Furthermore, in the case when the illumination source 32 generates an electron beam, the structure could be such that either a mask is used or a pattern can be directly formed on a substrate without the use of a mask.

The optical assembly 22 projects and/or focuses the light passing through the reticle 12 to the wafer 14. Depending upon the design of the exposure apparatus 10, the optical assembly 22 can magnify or reduce the image illuminated on the reticle 12. The optical assembly 22 need not be limited to a reduction system. It could also be a 1× or magnification system.

When the illumination source 32 is an excimer laser that generates far ultra-violet rays, glass materials such as quartz and fluorite that transmit far ultra-violet rays can be used in the optical assembly 22. When the illumination source 32 is a F₂ type laser or x-ray, the optical assembly 22 can be either catadioptric or refractive (a reticle should also preferably be a reflective type), and when the illumination source 32 generates an electron beam, the electron optics should preferably consist of electron lenses and deflectors. The optical path for the electron beams should be traced in vacuum.

Also, with an exposure device that employs vacuum ultra-violet radiation (VUV) of wavelength 200 nm or shorter, use of the catadioptric type optical system can be considered. Examples of the catadioptric type of optical system include the disclosure Japan Patent Application Disclosure No.8-171054 published in the Official Gazette for Laid-Open Patent Applications and its counterpart U.S. Pat. No. 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. patent application Ser. No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 20 holds and positions the reticle 12 relative to the optical assembly 22 and the wafer 14. Similarly, the wafer stage assembly 24 holds and positions the wafer 14 with respect to the projected image of the illuminated portions of the reticle 12 in the operational area. Depending upon the design, the exposure apparatus 10 can also include additional actuators to move the stage assemblies 20, 24. The wafer stage assembly 24 is described in more detail below.

Further, in photolithography systems, when linear motors (see U.S. Pat. Nos. 5,623,853 or 5,528,100) are used in the wafer stage assembly 24 or the reticle stage assembly 20, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,100 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Forces producing the necessary movement of the stages generate reaction forces that can affect performance of the photolithography system. Reaction forces generated by the wafer (substrate) stage motive forces can be mechanically transferred to the floor (ground) by use of a frame member as described in U.S. Pat. No. 5,528,100 and published Japanese Patent Application Disclosure No. 8-136475. Additionally, reaction forces generated by the reticle (mask) stage motive forces can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

As described above, a photolithography system (an exposure apparatus) according to the above described embodiments can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a comprehensive adjustment is performed to make sure that accuracy is maintained in the complete photolithography system. Additionally, it is desirable to manufacture an exposure system in a clean room where the temperature and cleanliness are controlled.

The measurement system 28 monitors movement of the reticle 12 and the wafer 14 relative to the optical assembly 22 or some other reference. With this information, the control system 26 can control the reticle stage assembly 20 to precisely position the reticle 12 and the wafer stage assembly 24 to precisely position the wafer 14. The design of the measurement system 28 can be varied. For example, the measurement system 28 can utilize multiple laser interferometers, encoders, and/or other measuring devices.

FIG. 1 only illustrates the portion of the measurement system 28 that monitors the position of the wafer 14 relative to the optical assembly 22. In this embodiment, the measurement system 28 that monitors the position of the wafer 14 (i) along an X axis, a Y axis, and a Z axis relative to the optical assembly 22 and (ii) about the X axis, the Y axis and the Z axis relative to the optical assembly 22. In FIG. 1, the measurement system 28 includes a plurality of interferometer blocks 36 that are secured to the optical assembly 22 and a plurality of rigid mirror components 38 that are secured to the wafer stage assembly 24. The present invention utilizes squeeze film type damping between the mirror components 38 and the wafer stage assembly 24 to dampen vibration of the mirror components 38. This allows the measurement system 28 to accurately measurement of the position of the wafer 14. As a result thereof, the quality of the integrated circuits formed on the wafer 14 is improved.

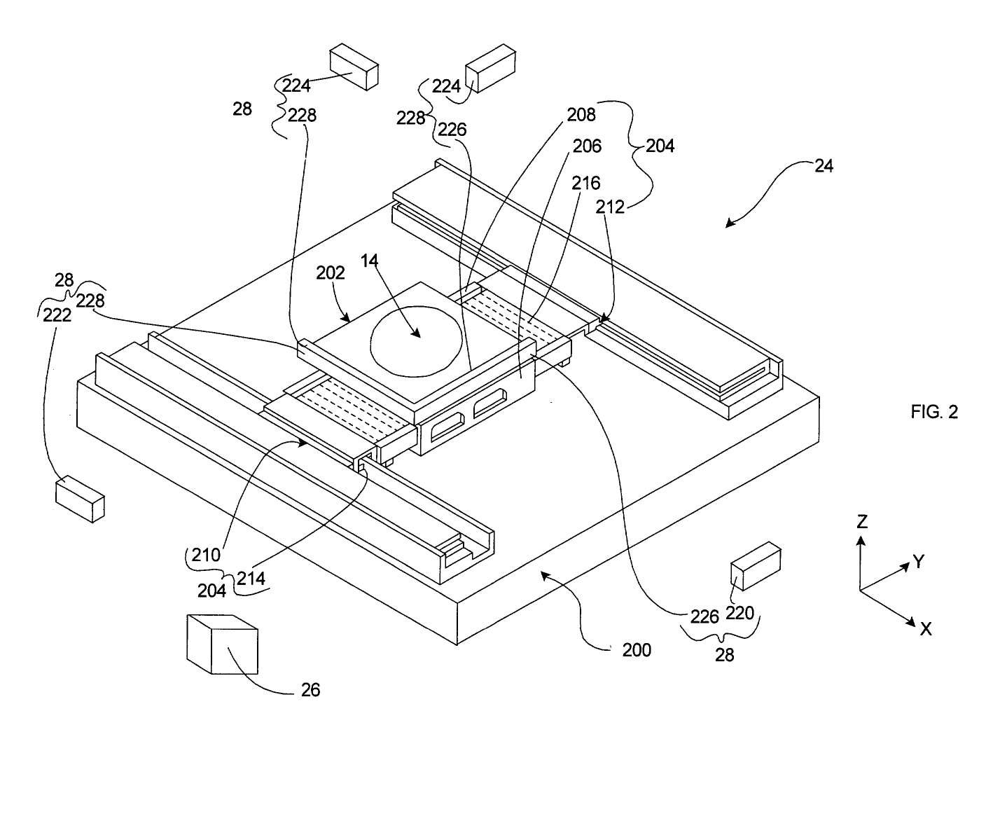

FIG. 2 is a perspective view of the wafer stage assembly 24, the wafer 14, the control system 26, and the measurement system 28. In FIG. 2, the wafer stage assembly 24 includes a stage base 200, a device stage 202, and a stage mover assembly 204. The stage assembly 24 can be used for precisely positioning the wafer 14 or another type of device or object during a manufacturing and/or an inspection process. For example, the designs provided herein can be incorporated into the reticle stage assembly.

The stage base 200 supports a portion of the stage assembly 24 above the mounting base 30 (illustrated in FIG. 1). The stage base 200 is generally rectangular plate shaped.

The device stage 202 retains the wafer 14. The device stage 202 includes a device holder such as a vacuum chuck, an electrostatic chuck, or some other type of clamp that retains the wafer 14. Alternatively, the device stage 202 can include multiple device holders for retaining multiple wafers.

The stage mover assembly 204 precisely moves and positions the device stage 202 to precisely position the device wafer 14. The design of the stage mover assembly 204 can vary. For example, the stage mover assembly 204 can move the device stage 202 with six degrees of freedom or three degrees of freedom. In FIG. 2, the stage mover assembly 204 moves the device stage 202 with six degrees of freedom and includes (i) a mover housing 206, (ii) a stage mover (not shown), (iii) a guide assembly 208, (iii) a left X guide mover 210, (iv) a right X guide mover 212, (v) a Y guide mover 214, and (vi) a Y housing mover 216.

The mover housing 206 is somewhat rectangular tube shaped and includes a guide opening that is sized and shaped to receive a portion of the guide assembly 208. The mover housing 206 can be maintained above the stage base 200 with a vacuum preload type fluid bearing and the mover housing 206 can be maintained apart from the guide assembly 208 with opposed fluid bearings.

The stage mover can include one or more actuators for moving the device stage 202 relative to the mover housing 206 along the Z axis, about the X axis and about the Y axis. Additionally, the stage mover can include additional actuators for moving the device stage 202 relative to the mover housing 206 along the X axis, along the Y axis and about the Z axis. Still alternatively, the device stage 202 can be fixedly secured directly to the top of the mover housing 206.

The guide assembly 208 guides the movement of the mover housing 206 along the Y axis. In FIG. 2, the guide assembly 208 is generally rectangular shaped and includes a left end and a right end. The guide assembly 208 also includes a pair of spaced apart, guide fluid pads. The guide fluid pads and the guide assembly 208 can be supported above the stage base 200 with a vacuum preload type, fluid bearing.

The guide movers 210, 212, 214 and the Y housing mover 216 move the guide assembly 208 and the mover housing 206 relative to the stage base 200. In FIG. 2, (i) the X guide movers 210, 212 move the guide assembly 208 and the mover housing 206 with a relatively large displacement along the X axis and with a limited range of motion about the Z axis (theta Z), (ii) the Y guide mover 214 moves the guide assembly 208 with a small displacement along the Y axis, and (iii) the Y housing mover 216 moves the mover housing 206 with a relatively large displacement along the Y axis.

The mover 210, 212, 214, 216 can include one or more actuators or motors. In FIG. 2, the Y guide mover 214 includes a pair of opposed attraction only electromagnetic actuators, each X guide movers 210, 212 is a commutated, linear motor and the Y housing mover 216 is a commutated, linear motor.

The control system 26 controls the stage mover assembly 204 to precisely position the device stage 202 and the device 14. In FIG. 2, the control system 26 directs and controls the current to each of the X guide movers 210, 212 to control movement of the guide assembly 208 along the X axis and about the Z axis. Similarly, the control system 26 directs and controls the current to the Y housing mover 216 to control the position of the mover housing 206 along the guide assembly 208 and the Y guide mover 214 to control movement of the guide assembly 208 along the Y axis. Additionally, the control system 26 controls the stage movers to control the position of the device stage 202 relative to the mover housing 206.

The measurement system 28 monitors movement of the device stage 202 relative to the optical assembly 22 (illustrated in FIG. 1). With this information, the stage mover assembly 204 precisely positions of the device stage 202. In FIG. 2, the measurement system 28 monitors the position of the device stage 202 (i) along the X axis, the Y axis, and the Z axis relative to the optical assembly and (ii) about the X axis, the Y axis and the Z axis relative to the optical assembly. In FIG. 2, the measurement system 28 includes an X block 220, a Y block 222, a pair of Z blocks 224, a first mirror component 226 and a second mirror component 228.

The X block 220 interacts with the first mirror component 226 to monitor the location of the device stage 202 along the X axis and about the Z axis (theta Z). More specifically, the X block 220 generates a pair of spaced apart laser beams (not shown) and detects the beams that are reflected off of the first mirror component 226. With this information, the location of the device stage 202 along the X axis and about the Z axis can be monitored.

Similarly, the Y block 222 interacts with the second mirror component 228 to monitor the position of the device stage 202 along the Y axis. More specifically, the Y block 202 generates a laser beam and detects the beam that is reflected off of the second mirror component 228. With this information, the location of the device stage 202 along the Y axis can be monitored.

Further, the Z blocks 224 interact with the first mirror component 226 and the second mirror component 228 to monitor the position of the device stage 202 along the Z axis, about the X axis, and about the Y axis. More specifically, the Z blocks 224 generate three laser beams and detect the beams that are reflected off of the mirrors 226, 228. With this information, the location of the device stage 202 along the Z axis, about the X axis, and about the Y axis can be monitored.

The blocks 220, 222, 224 can be secured to the optical assembly, spaced apart from the device stage 202. Each of the mirror components 226, 228 is generally rectangular shaped. The first mirror component 226 extends along one side of the device stage 202 and the second mirror component 228 extends along another side of the device stage 202, substantially perpendicular to the first mirror component 226.

The present invention utilizes squeeze film damping to dampen vibration of mirror components 226, 228. As a result thereof, the measurement system 28 can more accurately monitor the relative positions of the reticle 12 and the wafer 14. The present invention provides a number of methods that can be used to precisely dampen vibration of the mirror components 226, 228. As a result thereof, the measurement system 20 can accurately monitor the position of the device stage 202 and the stage mover assembly 204 can precisely position the device stage 202. It should be noted that the concepts provided herein can be used in the reticle stage assembly 20, the wafer stage assembly 24 and/or another type of stage assembly.

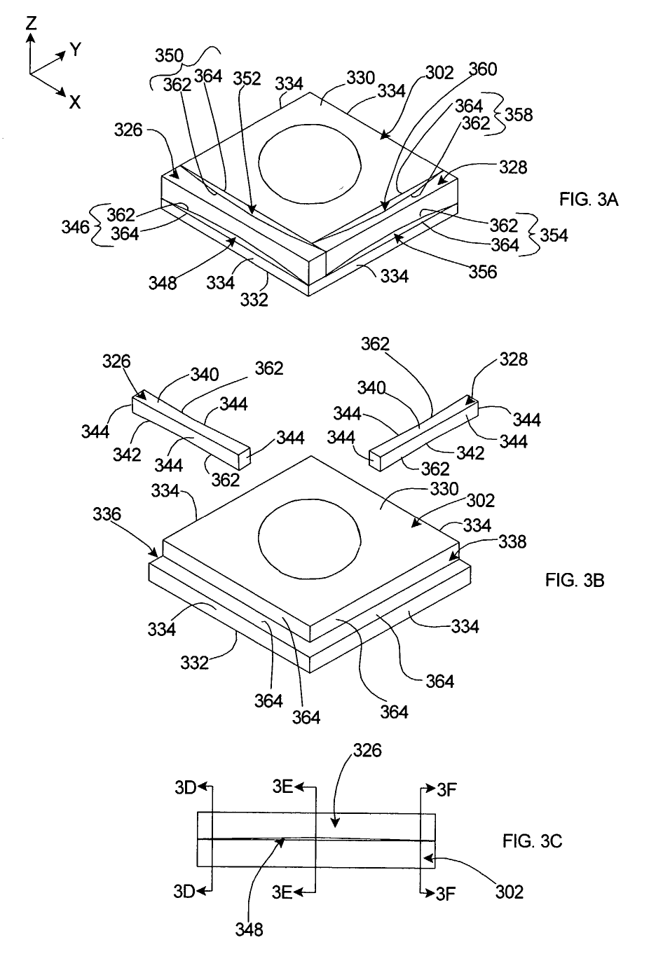

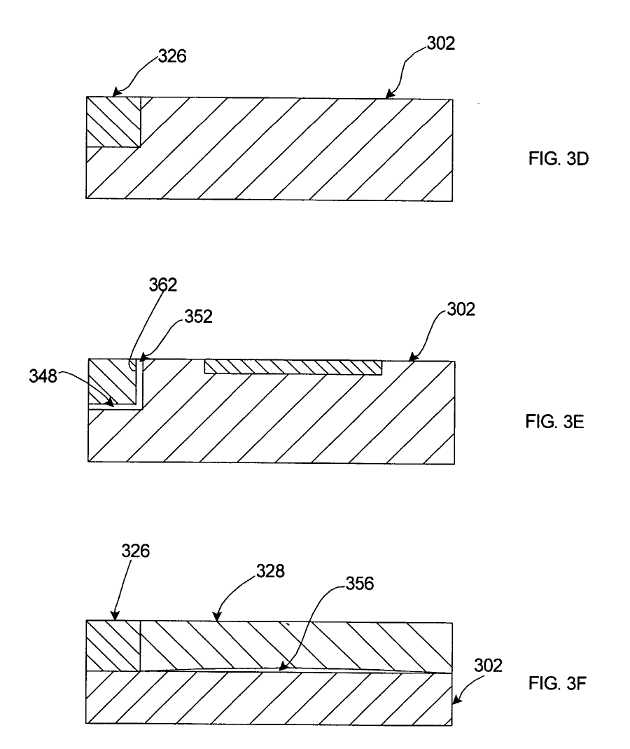

FIG. 3A illustrates a top perspective view and FIG. 3B illustrates an exploded perspective view of a first embodiment of the device stage 302, the first mirror component 326 and the second mirror component 328. The device stage 302 is generally rectangular plate shaped and includes a stage top 330, a stage bottom 332 and four stage sides 334. In this embodiment, the device stage 302 also includes a rectangular shaped first recess 336 in the stage top 330 that extends along one of the stage sides 334 and a rectangular shaped second recess 338 in the stage top 330 that extends along another one of the stage sides 334. The first recess 336 receives the first mirror component 326 and the second recess 338 receives the second mirror component 328.

Each mirror component 326, 328 is generally rigid and rectangular bar shaped and includes a mirror top 340, a mirror bottom 342 and four mirror sides 344. Each mirror component 326, 328 can be made of stainless steel and can be secured with an adhesive, one or more clamps, or one or more fasteners to the device stage 302. In this FIG. 3A, each end, of each mirror component 326, 328 is secured to the device stage 202.

In this embodiment, (i) the first mirror component 326 and the device stage 302 cooperate to define a first pair of adjoining surfaces 346 with a first fluid gap 348 therebetween and a second pair of adjoining surfaces 350 with a second fluid gap 352 therebetween, and (ii) the second mirror component 328 and the device stage 302 cooperate to define a first pair of adjoining surfaces 354 with a first fluid gap 356 therebetween and a second pair of adjoining surfaces 358 with a second fluid gap 360 therebetween. Each pair of adjoining surfaces 346, 350, 354, 358 includes a component adjoining surface 362 and a stage adjoining surface 364. The adjoining surfaces 362, 364 should each have a good surface finish, e.g. a surface roughness of less than approximately 0.1 microns.

It should be noted that each fluid gap 348, 352, 356, 360 is relatively small and the size of each fluid gap 348, 352, 356, 360 is greatly exaggerated in the Figures for clarity. In most cases, if drawn to scale, the fluid gaps 348, 352, 356, 360 would not be visible in the Figures. Further, each of the fluid gaps 348, 352, 356, 360 contains a fluid, e.g. air, that provides provide squeeze film type damping of the respective mirror component 326, 328. In this design, the fluid gaps for each mirror component 326, 328 are arranged to provide damping in two orthogonal directions. More specifically, for the first mirror component 326, the first fluid gap 348 provides damping along the Z axis, the second fluid gap 352 provides damping along the Y axis, and the fluid gaps 348, 352 cooperate to provide torsional damping along the length of the fist mirror component 326. Similarly, for the second mirror component 328, the first fluid gap 356 provides damping along the Z axis, the second fluid gap 360 provides damping along the X axis, and the fluid gaps 356, 360 cooperate to provide torsional damping along the length of the second mirror component 328.

In this embodiment, the first fluid gap 348 and the second fluid gap 352 for the first mirror component 326 are positioned directly between the first mirror component 326 and the device stage 302, and the first fluid gap 356 and the second fluid gap 360 for the second mirror component 328 are positioned directly between the second mirror component 328 and the device stage 302. It should be noted that the size of the each fluid gap 348, 352, 356, 360 varies across the adjoining surfaces 362, 364. More specifically, at a left end and at a right end of each pair of adjoining surfaces 346, 350, 354, 358, the fluid gap is approximately zero and the respective mirror component 326, 328 is touching and is secured to the device stage 302. However, intermediate the ends, the fluid gap is greatest and can be between approximately 8 and 12 microns, or between approximately 4 and 16 microns. Stated another way, each fluid gap 348, 352, 356, 360 is zero at each end and increases gradually as you move to intermediate the ends.

As provided herein, the squeeze film damping type arrangement utilizes a squeeze film bounded by adjoining surfaces 362, 364, and each fluid gap 348, 352, 356, 360 between the adjoining surfaces 362, 364 forms a wedge with a diverging gap size as one moves from the ends where the mirror components 226, 228 are clamped, connected or merely touching.

In this embodiment, each stage adjoining surface 364 is substantially planar shaped, while each component adjoining surface 362 is slightly arched. Further, the surface geometry of the component adjoining surface 362 may be essentially that of the surface geometry of the stage adjoining surface 364 in the deflected configuration when the mirror components 326, 328 are experiencing vibratory motion. It should be noted that the fluid gaps 348, 352, 356, 360 may tend to zero over some or all of its active length during at least a portion of the time during some of the cycles of vibratory motion of the mirror components 226, 228. Whether the fluid gap 348, 352, 356, 360 closure occurs depends on the magnitude of the vibratory excitation.

FIGS. 3C illustrates the side view of the first embodiment of the first mirror component 326, the device stage 302 and the first fluid gap 348 and FIGS. 3D-3F each illustrate alternate cross-sectional views taken from FIG. 3C of the first mirror component 326, the device stage 302, the first fluid gap 348, the second fluid gap 352, the second mirror component 328 and/or the first fluid gap 356.

The process used to form the fluid gaps 348, 352, 356, 360 can be varied. For example, the fluid gaps 348, 352, 356, 360 can be formed by (i) producing a very shallow scallop in the component adjoining surfaces 362 by heating or cooling selected portions of the mirror component 326, 328 while machining or grinding the component adjoining surfaces 362, the heating and cooling producing heat strain (micro displacements) in the component adjoining surfaces 362 being machined or ground and the component adjoining surfaces 362 will attain a scalloped geometry when the solid temperature returns to normal. (ii) producing a very shallow scallop in component adjoining surfaces 362 by means of mechanically clamping or straining portions of the component adjoining surfaces 362 while machining or grinding the component adjoining surfaces 362, the clamping or straining producing mechanical strain (micro displacements) in the component adjoining surfaces 362. The component adjoining surfaces 362 will attain a scalloped geometry when the stress state returns to normal. A combination of the two procedures outlined above or alternate procedures can be utilized in forming the gaps 348, 352, 356, 360.

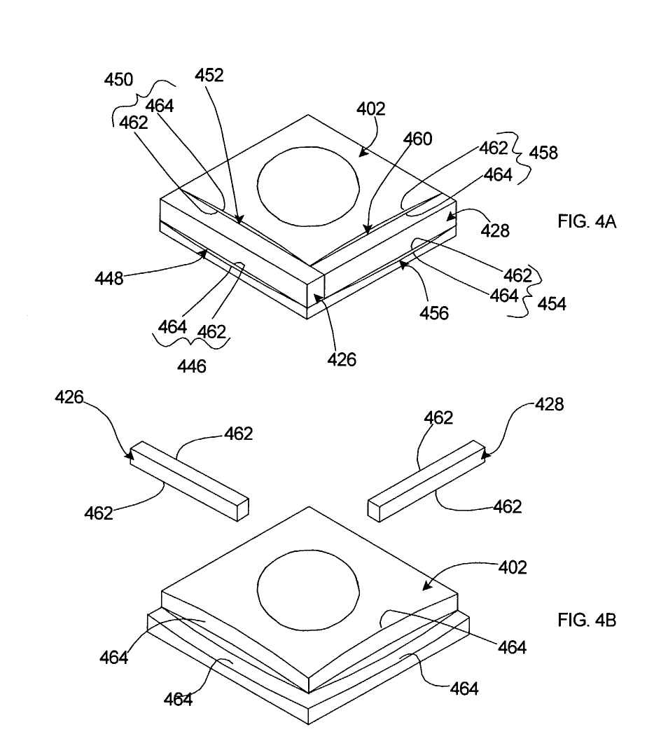

FIGS. 4A illustrates a top perspective view and FIG. 4B illustrates an exploded perspective view of a second embodiment of the device stage 402, the first mirror component 426 and the second mirror component 428. The device stage 402 and the mirror components 426, 428 are somewhat similar to the corresponding components described above. For example, in this embodiment, (i) the first mirror component 426 and the device stage 402 cooperate to define a first pair of adjoining surfaces 446 with a first fluid gap 448 therebetween and a second pair of adjoining surfaces 450 with a second fluid gap 452 therebetween, and (ii) the second mirror component 428 and the device stage 402 cooperate to define a first pair of adjoining surfaces 454 with a first fluid gap 456 therebetween and a second pair of adjoining surfaces 458 with a second fluid gap 460 therebetween. Each pair of adjoining surfaces 446, 450, 454, 458 includes a component adjoining surface 462 and a stage adjoining surface 464. However, this embodiment, each stage adjoining surface 464 is slightly arched shaped while each stage adjoining surface 462 is substantially planar.

The fluid gaps 448, 452, 456, 460 can be formed by (i) producing a very shallow scallop in the stage adjoining surfaces 464 by heating or cooling selected portions while machining or grinding, (ii) producing a very shallow scallop in stage adjoining surfaces 464 by means of mechanically clamping or straining portions while machining or grinding, or (iii) a combination of the two procedures.

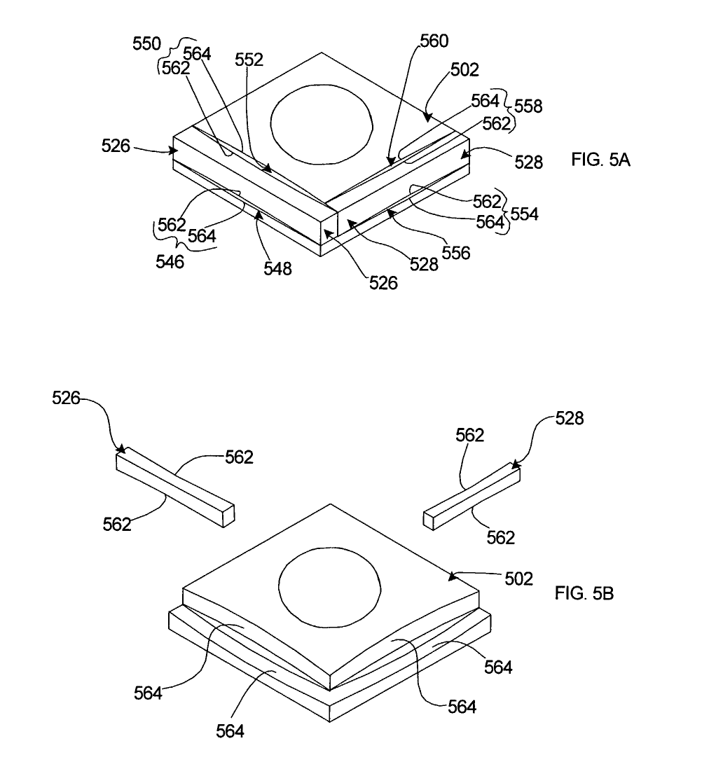

FIGS. 5A illustrates a top perspective view and FIG. 5B illustrates an exploded perspective view of a third embodiment of the device stage 502, the first mirror component 526 and the second mirror component 528. The device stage 502 and the mirror components 526, 528 are somewhat similar to the corresponding components described above. For example, in this embodiment, (i) the first mirror component 526 and the device stage 502 cooperate to define a first pair of adjoining surfaces 546 with a first fluid gap 548 therebetween and a second pair of adjoining surfaces 550 with a second fluid gap 552 therebetween, and (ii) the second mirror component 528 and the device stage 502 cooperate to define a first pair of adjoining surfaces 554 with a first fluid gap 556 therebetween and a second pair of adjoining surfaces 558 with a second fluid gap 560 therebetween. Each pair of adjoining surfaces 546, 550, 554, 558 includes a component adjoining surface 562 and a stage adjoining surface 564. However, this embodiment, each adjoining surface 562, 564 is substantially slightly arched.

The fluid gaps 548, 552, 556, 560 can be formed by (i) producing a very shallow scallop in the adjoining surfaces 562, 564 by heating or cooling selected portions while machining or grinding. (ii) producing a very shallow scallop in adjoining surfaces 562, 564 by means of mechanically clamping or straining portions while machining or grinding, or (iii) a combination of the two procedures.

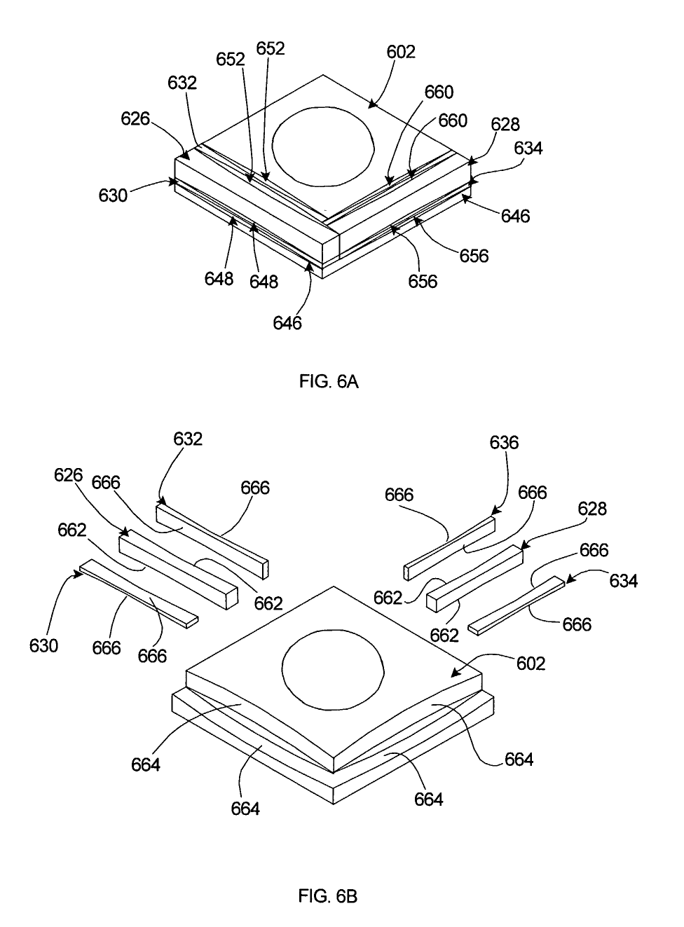

FIGS. 6A illustrates a top perspective view and FIG. 6B illustrates an exploded perspective view of a fourth embodiment of the device stage 602, the first mirror component 626 and the second mirror component 628. The device stage 602 and the mirror components 626, 628 are somewhat similar to the corresponding components described above. However, in this embodiment, (i) a first, first damping unit 630 is positioned between the first mirror component 626 and the device stage 602, (ii) a second, first damping unit 632 is positioned between the first mirror component 626 and the device stage 602, (iii) a first, second damping unit 634 is positioned between the second mirror component 628 and the device stage 602, and (iv) a second, second damping unit 636 is positioned between the second mirror component 628 and the device stage 602. Each damping unit 630, 632, 634, 636 is rigid, thin, substantially rectangular shaped and positioned between one of the mirror components 626, 628 and the device table 602.

In this embodiment, (i) the first, first damping unit 630 is used to create a pair of first fluid gaps 648 between the first mirror component 626 and the device stage 602, (ii) the second, first damping unit 632 is used to create a pair of second fluid gaps 652 between the first mirror component 626 and the device stage 602, (iii) the first, second damping unit 634 is used to create a pair of first fluid gaps 656 between the second mirror component 628 and the device stage 602, and (iv) the second, second damping unit 636 is used to create a pair of second fluid gaps 660 between the second mirror component 628 and the device stage 602.

In this embodiment, each damping unit 630, 632, 634, 636 is a thin member having two gaps situated on opposite sides in such a manner that small angular deviations of the surfaces where the mirror component is clamped or connected to the device stage 602, will not cause closure of the fluid gap. Alternatively, for example, each damping unit 630, 632, 634, 636 can be used to create a single fluid gap.

Further, each of the fluid gaps 648, 652, 656, 660 is positioned between a pair of adjoining surfaces 646. In this embodiment, each pair of adjoining surfaces 646 includes a unit adjoining surface 666 and either a component adjoining surface 662 or a stage adjoining surface 664. In this embodiment, each adjoining surface 662, 664, 666 is slightly arched. Alternatively, for each pair of adjoining surfaces 646, one of the surfaces can be planar shaped.

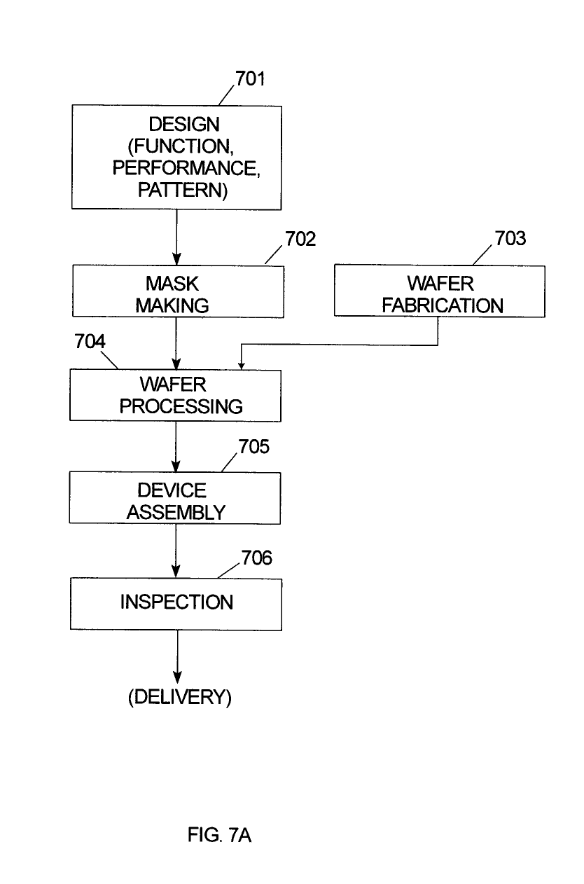

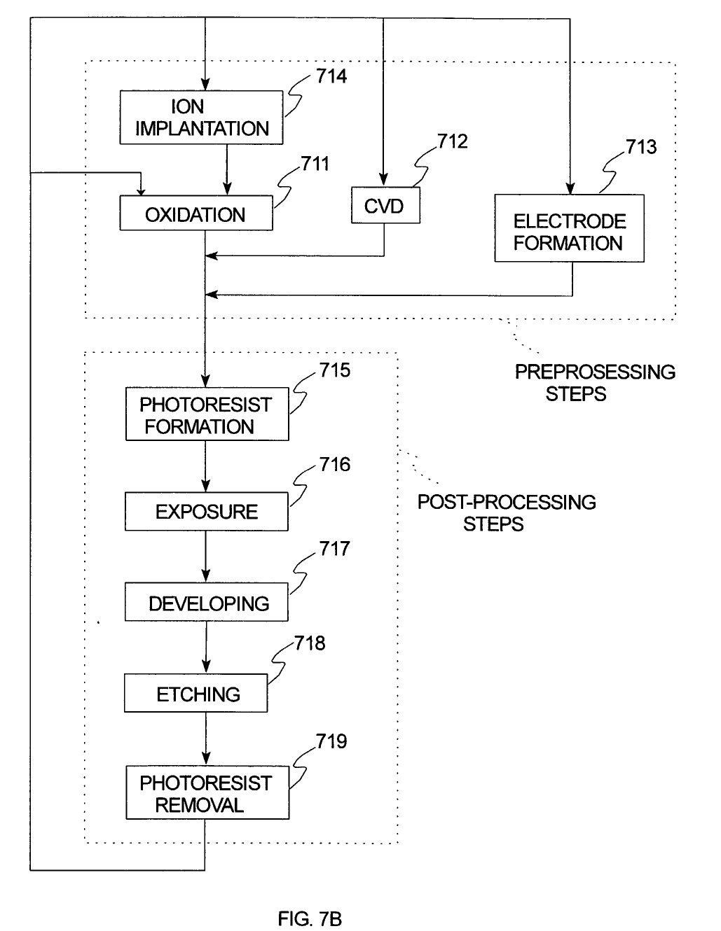

Semiconductor devices can be fabricated using the above described systems, by the process shown generally in FIG. 7A. In step 701 the device's function and performance characteristics are designed. Next, in step 702, a mask (reticle) having a pattern is designed according to the previous designing step, and in a parallel step 703 a wafer is made from a silicon material. The mask pattern designed in step 702 is exposed onto the wafer from step 703 in step 704 by a photolithography system described hereinabove in accordance with the present invention. In step 705 the semiconductor device is assembled (including the dicing process, bonding process and packaging process), finally, the device is then inspected in step 706.

FIG. 7B illustrates a detailed flowchart example of the above-mentioned step 704 in the case of fabricating semiconductor devices. In FIG. 7B, in step 711 (oxidation step), the wafer surface is oxidized. In step 712 (CVD step), an insulation film is formed on the wafer surface. In step 713 (electrode formation step), electrodes are formed on the wafer by vapor deposition. In step 714 (ion implantation step), ions are implanted in the wafer. The above mentioned steps 711-714 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 715 (photoresist formation step), photoresist is applied to a wafer. Next, in step 716 (exposure step), the above-mentioned exposure device is used to transfer the circuit pattern of a mask (reticle) to a wafer. Then in step 717 (developing step), the exposed wafer is developed, and in step 718 (etching step), parts other than residual photoresist (exposed material surface) are removed by etching. In step 719 (photoresist removal step), unnecessary photoresist remaining after etching is removed.

Multiple circuit patterns are formed by repetition of these preprocessing and post-processing steps.

While the particular precision assembly as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An apparatus that precisely moves a device, the apparatus comprising:
a stage assembly including a device stage that retains the device and a stage mover assembly connected to the device stage, the stage mover assembly moves the device stage; and
a first mirror component that is secured to the device stage, the first mirror component being used for monitoring the position the device stage;
wherein a first fluid gap exists between the first mirror component and the device stage, the first fluid gap providing squeeze film damping of the first mirror component along a first axis.

2. The apparatus of claim 1 wherein the first fluid gap is formed between a stage adjoining surface on the device stage and a component adjoining surface on the first mirror component.

3. The apparatus of claim 2 wherein one of the adjoining surfaces is substantially planar shaped and one of the adjoining surfaces is slightly arched shaped.

4. The apparatus of claim 2 wherein each of the adjoining surfaces is slightly arch shaped.

5. The apparatus of claim 1 further comprising a first damping unit positioned between the first mirror component and the device stage.

6. The apparatus of claim 5 wherein the first fluid gap is positioned between the first mirror component and the first damping unit.

7. The apparatus of claim 5 wherein the first fluid gap is positioned between the first damping unit and the device stage.

8. The apparatus of claim 5 wherein the first fluid gap includes a first, first fluid gap positioned between the first mirror component and the first damping unit and a second, first fluid gap positioned between the first mirror component and the device stage.

9. The apparatus of claim 1 wherein a second fluid gap exists between the first mirror component and the device stage, the second fluid gap providing squeeze film damping of the first mirror component along a second axis that is substantially orthogonal to the first axis.

10. The apparatus of claim 9 wherein the fluid gaps cooperate to provide torsional damping of the first mirror component.

11. The apparatus of claim 9 further comprising a first damping unit positioned between the first mirror component and the device stage and a second damping unit positioned between the first mirror component and the device stage.

12. The apparatus of claim 1 wherein the size of the fluid gap varies along the first mirror component.

13. The apparatus of claim 12 wherein the first mirror component includes opposed ends and the size of the fluid gap is greatest approximately intermediate the opposed ends.

14. The apparatus of claim 1 further comprising a second mirror component secured to the device stage, the second mirror component being used for monitoring the position the device stage; wherein a fluid gap exists between the second mirror component and the device stage, the fluid gap providing squeeze film damping of the second mirror component along the first axis.

15. The apparatus of claim 1 further comprising an interferometer block that directs a beam at the first mirror component to monitor the position of the first mirror component.

16. An exposure apparatus including the apparatus of claim 1.

17. A device manufactured with the exposure apparatus according to claim 16.

18. A wafer on which an image has been formed by the exposure apparatus of claim 16.

19. An assembly comprising:
a stage;
a stage mover assembly connected to the stage, the stage mover assembly moves the stage; and
a substantially rigid, first component that is secured to the stage;
wherein a first fluid gap exists between the first component and the stage, the first fluid gap providing squeeze film damping of the first component along a first axis; and wherein a second fluid gap exists between the first component and the stage, the second fluid gap providing squeeze film damping of the first rigid component along a second axis that is substantially orthogonal to the first axis.

20. The assembly of claim 19 wherein the stage retains a device and the first component is mirror that is used to monitor the position of the stage.

21. The assembly of claim 19 wherein the first fluid gap is formed between a stage adjoining surface on the stage and a component adjoining surface on the first component.

22. The assembly of claim 21 wherein one of the adjoining surfaces is substantially planar shaped and one of the adjoining surfaces is slightly arched shaped.

23. The assembly of claim 21 wherein each of the stage adjoining surfaces is slightly arch shaped.

24. The assembly of claim 19 further comprising a first damping unit positioned between the first component and the stage.

25. The assembly of claim 24 wherein the first fluid gap is positioned between the first component and the first damping unit.

26. The assembly of claim 24 wherein the first fluid gap is positioned between the first damping unit and the stage.

27. The assembly of claim 24 wherein the first fluid gap includes a first, first fluid gap positioned between the first component and the first damping unit and a second, first fluid gap positioned between the first component and the stage.

28. The assembly of claim 19 wherein the fluid gaps cooperate to provide torsional damping of the first component.

29. The assembly of claim 19 further comprising a first damping unit positioned between the first component and the stage and a second damping unit positioned between the first component and the stage.

30. The assembly of claim 19 wherein the size of each fluid gap varies along the first component.

31. The assembly of claim 30 wherein the first component includes opposed ends and the size of each fluid gap is greatest approximately intermediate the opposed ends.

32. An exposure apparatus including the assembly of claim 19.

33. A device manufactured with the exposure apparatus according to claim 32.

34. A wafer on which an image has been formed by the exposure apparatus of claim 32.

35. A method for making a stage assembly for precisely moving a device, the method comprising the steps of:
providing a device stage that retains the device;
coupling a stage mover assembly to the device stage, the stage mover assembly moving the device stage;
securing a mirror component to the device stage, the mirror component being used for monitoring the position the device stage; and
providing a first fluid gap between the mirror component and the device stage, the first fluid gap providing squeeze film damping of the mirror component along a first axis.

36. The method of claim 35 wherein the step of providing a first fluid gap includes the step of positioning a first damping unit between the mirror component and the device stage.

37. The method of claim 35 further comprising the step of positioning a second fluid gap between the mirror component and the device stage, the second fluid gap providing squeeze film damping of the mirror component along a second axis that is substantially orthogonal to the first axis.

38. The method of claim 35 further comprising the step of directing a beam from an interferometer block at the mirror component to monitor the position of the mirror component.

39. A method for making an exposure apparatus that forms an image on a wafer, the method comprising the steps of:
providing an irradiation apparatus that irradiates the wafer with radiation to form the image on the wafer; and
providing the stage assembly made by the method of claim 35.

40. A method of making a wafer utilizing the exposure apparatus made by the method of claim 39.

41. A method of making a device utilizing the exposure apparatus made by the method of claim 39.

42. A method for making an assembly, the method comprising the steps of:
providing a stage;
coupling a stage mover assembly to the stage, the stage mover assembly moves the stage; and
securing a substantially rigid, first component to the stage;
providing a first fluid gap between the first component and the stage, the first fluid gap providing squeeze film damping of the first component along a first axis; and
providing a second fluid gap between the first component and the stage, the second fluid gap providing squeeze film damping of the first component along a second axis that is substantially orthogonal to the first axis.

43. The method of claim 42 wherein the step of providing a first fluid gap includes the step of positioning a first damping unit between the first component and the stage and the step of providing a second fluid gap includes the step of positioning a second damping unit between the first component and the stage.

44. A method for making an exposure apparatus that forms an image on a wafer, the method comprising the steps of:
providing an irradiation apparatus that irradiates the wafer with radiation to form the image on the wafer; and
providing the assembly made by the method of claim 42.

45. A method of making a wafer utilizing the exposure apparatus made by the method of claim 44.

46. A method of making a device utilizing the exposure apparatus made by the method of claim 44.
